(19) United States
(12) Patent Application Publication
(10) Pub. No.: US 2011/0153461 A1
(43) Pub. Date: Jun. 23, 2011

(54) ENROLLMENT AUTHENTICATION WITH ENTRY OF PARTIAL PRIMARY ACCOUNT NUMBER (PAN)

(75) Inventor: Vijay Royyuru, Norristown, PA (US)

(73) Assignee: First Data Corporation, Greenwood Village, CO (US)

(21) Appl. No.: 12/641,239

(22) Filed: Dec. 17, 2009

(51) Int. Cl. G06Q 30/00; G06Q 50/00; G06Q 40/00; G06Q 10/00; H04M 1/64

(52) U.S. Cl. 705/27.1; 705/35; 705/325; 379/88.04; 705/26.82

(57) ABSTRACT

This disclosure describes, generally, methods and systems for implementing enrollment authentication. The method includes receiving from a customer a partial PAN and an issuing financial institution. Further, based on transaction history related to the partial PAN, the method presents challenge questions to the customer, receive answers to the challenge questions. Then, based on the partial PAN, the issuing financial institution, and the answers to the challenge questions, a complete PAN may be resolved. The method includes prompting the customer to select a mutual trust phrase, receiving the selected mutual trust phrase, and placing a call from an interactive voice response (IVR) system to the customer. Further, the method includes playing back to the customer the selected mutual challenge phrase, receiving, from a telephone (e.g., entered on touch-tone keypad or spoken and translated to text), the customer's PIN associated with the complete PAN, and using the complete PAN and PIN combination to authenticate the customer.

### RELATED APPLICATION

The application is related to co-pending U.S. patent application Ser. No. 11/677, 967, Attorney Docket No. 020375-081000US, entitled, MANAGEMENT OF FINANCIAL TRANSACTIONS USING DEBIT NETWORKS, filed on Feb. 22, 2007, which is incorporated by reference in its entirety for any and all purposes.

### FIELD OF THE INVENTION

The present invention relates, in general, to financial account enrollment, and more particularly, to enrollment authentication using a partial primary account number (PAN).

### BACKGROUND

Presently, presentation of a financial card (e.g., a STAR network card) or data from the financial card and entry of a PIN into a tamper-resistant PIN entry device are how customers are authenticated. New products and services such as eCommerce transactions, mobile banking transactions, and mobile payment transactions are not capable of accepting PIN entry into a tamper-resistant PIN entry device. Hence, first-time enrollment requests coming directly from a consumer to the financial network still require authentication. Upon successful authentication of such first-time enrollment request, the payment network may issue new credentials to the customer, for presentation during authentication of the new products or services.

Accordingly, a problem with current implementation is authenticating a first-time enrollment request for a new product or service from the payment network, that meets or exceeds the security of a present-day PIN-based financial card transaction. With general (non-Internet, non-mobile, etc.) enrollment authentication a customer the financial card at a magnetic stripe reader and enters the PIN into a secure PIN entry device. This is not possible in eCommerce and mobile enrollment authentication because customers are not physically present during the enrollment process, rather they are attempting to conduct the enrollment process remotely. Hence, improvements in the art are needed.

### BRIEF SUMMARY

The tools provided by various embodiments of the invention include, without limitation, methods, systems, and/or software products. Mainly by way of example, a method might comprise receiving from a customer a partial primary account number (PAN) and the name of an issuing financial institution of the partial PAN. Further, based on transaction history related to the partial PAN, the method presents challenge questions to the customer, and receives answers to the plurality of challenge questions. Then, based on the partial PAN, the issuing financial institution, and the answers to the challenge questions, the complete PAN is resolved. The method further includes prompting the customer to select a mutual trust phrase, receiving the selected mutual trust phrase, and placing a call from an interactive voice response (IVR) system to the customer. Further, the method includes playing-back to the customer the selected mutual challenge phrase, receiving, from a telephone (e.g., entered on a touch-tone phone keypad, spoken and translated to text, etc.), the customer's personal identification number (PIN) associated with the complete PAN, and using the complete PAN and PIN combination to authenticate the customer.

A machine-readable medium for implementing enrollment authentication is provided. The machine-readable medium includes instruction for receiving from a customer a partial primary account number (PAN) and an issuing financial institution of the partial PAN. Further, based on transaction history related to the partial PAN, the machine-readable medium includes instructions for presenting challenge questions to the customer, and receives answers to the plurality of challenge questions. Then, based on the partial PAN, the issuing financial institution, and the answers to the challenge questions, the complete PAN is resolved. The machine-readable medium further includes instructions for prompting the customer to select a mutual trust phrase, receiving the selected mutual trust phrase, and placing a call from an interactive voice response (IVR) system to the customer. Further, the machine-readable medium includes instructions for playing back to the customer the selected mutual challenge phrase, receiving, from a telephone (e.g., entered on a touch-tone phone keypad, spoken and translated to text, etc.), the customer's personal identification number (PIN) associated with the complete PAN, and using the complete PAN and PIN combination to authenticate the customer.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral to denote one of multiple similar components. When reference is made to a reference numeral without specification to an existing sublabel, it is intended to refer to all such multiple similar components.

FIG. 1 is a process flow diagram illustrating enrollment authentication using a partial PAN, in accordance with various embodiments of the invention.

FIG. 2 is a process flow diagram illustrating enrollment authentication using a partial PAN, in accordance with further embodiments of the invention.

FIG. 3 is a block diagram illustrating a system for implementing enrollment authentication using a partial PAN, in accordance with various embodiments of the invention.

FIG. 4 is a generalized schematic diagram illustrating a computer system, in accordance with various embodiments of the invention.

FIG. 5 is a block diagram illustrating a networked system of computers, which can be used in accordance with various embodiments of the invention.

### DETAILED DESCRIPTION OF THE INVENTION

While various aspects of embodiments of the invention have been summarized above, the following detailed description illustrates exemplary embodiments in further detail to enable one of skill in the art to practice the invention. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. Several embodiments of the invention are described below, and while various features are ascribed to different embodiments, it should be appreciated that the features described with respect to one embodiment may be incorporated with another embodiment as well. By the same token, however, no single feature or features of any described embodiment should be considered essential to the invention, as other embodiments of the invention may omit such features.

According to aspects of the present invention, a combination of data and techniques is used to authenticate a first-time enrollment request by gathering credentials from the consumer, as may be presented in a PIN-based financial transaction, without requiring entry of the PIN on a tamper-resistant PIN-entry device.

Enrollment authentication may be accomplished by entry of a partial PAN, transaction pattern challenge question(s) and response(s), mutual authentication on the enrollment web site, and entry of the PIN with mutual authentication on an interactive voice response (IVR) phone session. In one embodiment, the consumer enters only a few digits from their PAN (or card number). Alternatively, the consumer may be prompted to select the issuing financial institution, by name, instead of entering the left-most six digits of the PAN. A list of all issuing financial institutions and the associated PAN prefixes are maintained, and can be used to derive the left-most six digits of the PAN from this list. The consumer may then be asked to enter only the right-most four digits of the PAN. The card network provider can then look at a transaction repository database to locate matching transactions and associated PANs using just the left-most six digits and right-most four digits of the PAN. In the event that more than one PAN that matches this search criteria is found, transaction pattern challenge questions or transaction history challenge questions can be presented to the customer. The consumer's answers are then used to narrow the search and selection of a single PAN, without requiring the consumer to enter the complete PAN on the web site.

According to a further embodiment, a transaction pattern or transaction history challenge, as described in U.S. patent application Ser. No. 11/874,584, Attorney Docket No. 020375-086900US, entitled, APPLICANT AUTHENTICATION, filed Oct. 18, 2007, which is incorporated by reference in its entirety for any and all purposes, may be used. This method allows verification of the consumer's assertion that he/she is the owner of the PAN being presented, by re-using historical data from previously authenticated transactions and posing them as challenge questions to the consumer. The correct owner of the PAN would have conducted those historical transactions and therefore will know the answers to those challenge questions.

Further, mutual authentication is established in order to assure the legitimacy of the enrollment web site to the consumer. The web site may display some shared secret data to the consumer. This shared secret data is such that it is instantly recognized by the consumer as being a secret, or at least that is only shared between the consumer and the entity the consumer trusts for authenticating payments, such as the financial network or the consumer's issuing financial institution. This shared secret may be text, image, audio, or any combination thereof. By integrating mutual authentication with the dynamic nature of transaction pattern challenges, a dynamic variety of shared secrets can be established and used for enrollment authentication.

In order to assure the legitimacy of the Enrollment IVR phone session, the consumer can enter or select a short textual phrase at the enrollment web site. When the enrollment IVR calls the consumer on the phone, the IVR will use Text To Speech (TTS) technology to speak the phrase the consumer had selected on the web site. This will assure the consumer that the phone call is legitimate and is a continuation of the enrollment request at the web site. The consumer can then safely proceed with entry of the PIN to the IVR phone session using the phone key pad.

Entry of PIN to the IVR phone session is performed using the phone key pad, which is not a tamper-resistant PIN entry device. The consumer enters the partial PAN on the enrollment website. The consumer enters the PIN on the IVR session. The complete PAN inferred at the end of the transaction pattern challenge sequence on the web site is used. The PAN and the PIN are combined within a Hardware Security Module (HSM), using the current tamper-resistant technology. The first place that the PAN and PIN are brought together are within the HSM. As a result, the customer is authenticated, and enrollment can be completed.

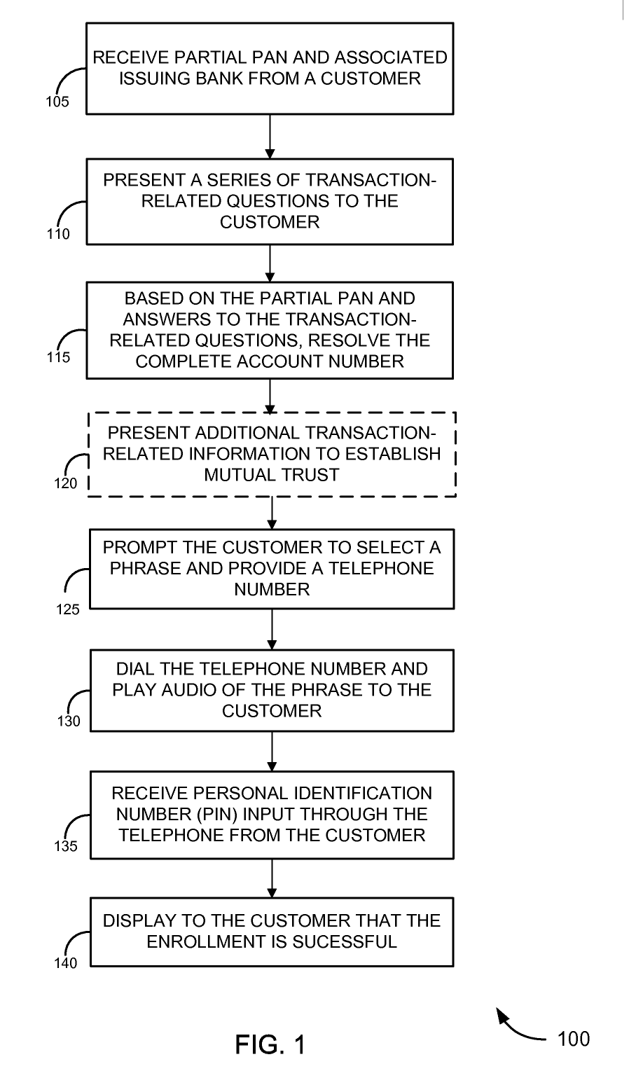

Turning now to FIG. 1 which illustrates a method 100 of implementing enrollment authentication using a partial PAN, according to embodiments of the present invention, at process block 105, a partial primary account number (PAN) and associated issuing bank (or financial institution) are received from a customer. This information may be received from the customer through a web site interface, a mobile device interface, etc. In one embodiment, the customer may have a card with the entire PAN, and the processing system is requesting that only a portion (or partial PAN) be presented. Furthermore, the card number (or PAN) implies the identity of the customer who owns the account. The PAN is sensitive information, and so the complete PAN should not be presented in the open (or unsecure). Accordingly, one aspect of the present invention is the determination of the complete PAN while only receiving a portion of the PAN.

In one embodiment, the partial PAN may include the right-most four digits of the PAN, or alternatively the partial PAN may include the left-most six digits, or a combination of both. Furthermore, any number of digits from any portion of the PAN may be used to form a partial PAN. Furthermore, the issuing financial institution may be selected from a list of institution names, or may be entered in by the customer.

For example, the customer gives the last four digits of their PAN, and chooses their bank by name. Then, the PANs are filtered using this information and a narrowed list of actual PANs which meet the criteria is returned. This may or may not be enough information to uniquely identify the customer's PAN, but the search is sufficiently narrowed down.

Accordingly, in order to further narrow the list of actual PANs to the customer's PAN, at process block 110, a series of transaction history-related challenge questions is presented to the customer. For example, historical transaction data from the narrowed list of PANs is retrieved and used to frame up one or more challenge questions to present to the customer. That historical data is used to frame the questions in such a way that it can initially be used to further narrow the list of PANs to a unique PAN. In one embodiment, the questions are presented in such a way that only the customer would be able to answer the questions correctly because the customer would know what transactions he/she had made, further narrowing the list to a unique PAN. For example, the customer may have purchased gas at a station on 5th and Market, in the last month, and a multiple choice question may include the gas station on 5th and Market with three or four incorrect gas stations. The correct answer and the fake answers are known, and the customer will know where he/she purchased gas in the last month. Thus, the customer will answer correctly and other people would not be able to answer correctly. Thus, a series of questions using this historical data is presented until the list of PANs is narrowed to a single unique PAN (i.e., the customer's PAN). Thus, based on the partial PAN and the answers to the challenge questions, the customer's complete PAN is identified (process block 115). In addition, there is a high level of confidence that the customer is who he/she says he/she is (i.e., due to the knowledge of the partial PAN and the correct answers to the challenge questions).

Optionally, at process block 120, additional transaction-related information may be presented in order to establish mutual trust between the customer and the authenticating entity. Partly, the fact that the authenticating entity has presented correct answer options to the customer establishes such a mutual trust (i.e., only the legitimate authenticating entity would have knowledge of the customer's detailed transactions). Additionally, a display of personal transaction information may be presented to the customer to further establish mutual trust. For example, the customer's last ten transactions may be displayed, etc.

At process block 125, the customer may be prompted to provide a telephone number and select or enter a phrase. For example, five or ten various phrases may be selected from, or a blank text box may be provided for the customer to enter in his/her own personal phrase. In response to the selected (or provided) phrase and the telephone number, while the customer is still in the web portal viewing the selected phrase, a call will be placed (e.g., an automated call from an IVR system) to the provided telephone number, and the selected/presented phrase will be played-back on the call (process block 130). As such, the customer is assured that the IVR call is actually originating from the authentication authority, and the customer has confidence in providing sensitive information on the call.

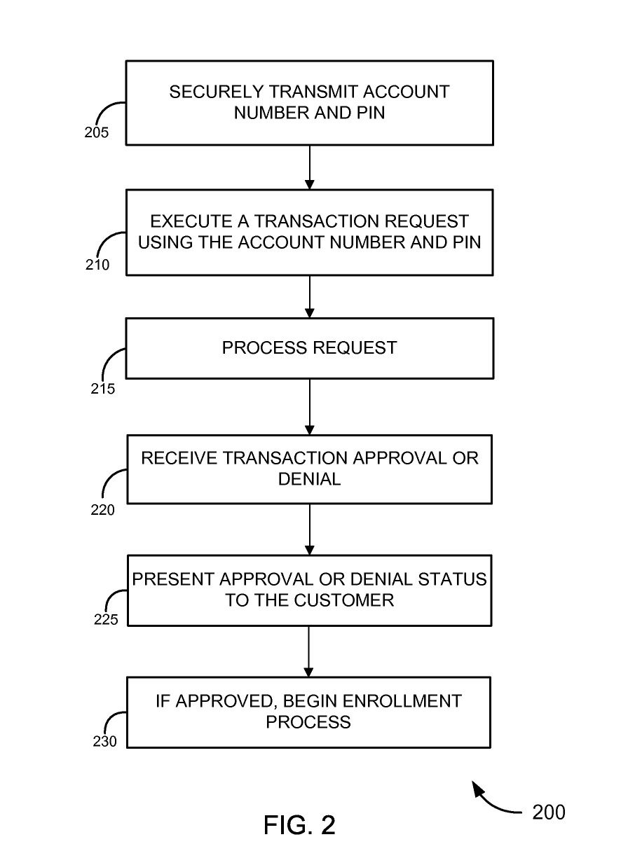

At process block 135, the customer will be prompted by the IVR system to provide the personal identification number (PIN) associated with the PAN. In this situation it is permissible to use the phone for PIN entry since the PIN entry would be done in the absence of any other data (e.g., the PAN, etc.). In essence, it is like punching in a bunch of random numbers; there is no context from which to derive the numbers' purpose or meaning. Then, if the PIN matches the PIN on file for the identified PAN, the customer may be authenticated and such a successful authentication may be displayed to the customer (process block 140). Further authentication processes may be completed, as described in FIG. 2, in addition to the authentication process described in FIG. 1.

Referring now to FIG. 2 which illustrates a method 200 of further enrollment authentication using a partial PAN, according to embodiments of the present invention, at process block 205, the PAN and the associated PIN may be securely transmitted to the issuing bank for authentication. For example, regulations and rules dealing with payments through networks typically require the PIN to be entered on such hardened devices (e.g., a tamper-resistant pin entry device). This is partially why a PIN is such a good credential for identification because no one knows the customer's PIN except the customer. Not even the issuing bank knows the PIN. The issuing bank stores the customer's PIN in an encrypted format. The entire process of transmitting the PIN from an ATM (or merchant) and taking it all the way back to the issuing bank and having the issuing bank check the PIN is encrypted. The issuing bank has a hardware device (or a security device) on its premises that receives this encrypted copy of the PIN on the transaction and checks it against an encrypted copy of the PIN from their database (all inside another hardened security module in the bank). So, the clear copy of the PIN is never available anywhere. Current regulations prohibit entry of a PIN on devices that are not tamper resistant. As an example, in theory, a customer could not enter his/her PIN through his/her computer keyboard because the keyboard is not a tamper-resistant device. Because there is no additional information presented with the PIN on the phone, entry of the PIN on the phone, either on the touch-tone keypad or spoken and translated to text, would be permissible since it would merely be construed as meaningless numbers without the context of the PAN.

Hence, at process block 210, a transaction authentication request using the PIN and the PAN is executed. The issuing bank or authenticating authority routinely executes transaction authentication requests in the normal course of business, and such a request would not be irregular. However, in this situation, no actual underlying financial transaction exists, but instead this request is a “dummy” or empty transaction request. The purpose of the transaction request in this situation is simply to authenticate the validity of the PIN/PAN combination derived from method 100. Accordingly, at process block 215, the transaction request may be processed.

At process block 220, the transaction request is either approved or denied. If it is approved, then such approval (in conjunction with the information gathered in method 100) authenticates the customer. Such approval may then be presented to the customer (process block 225), and the enrollment process may be initiated (process block 230).

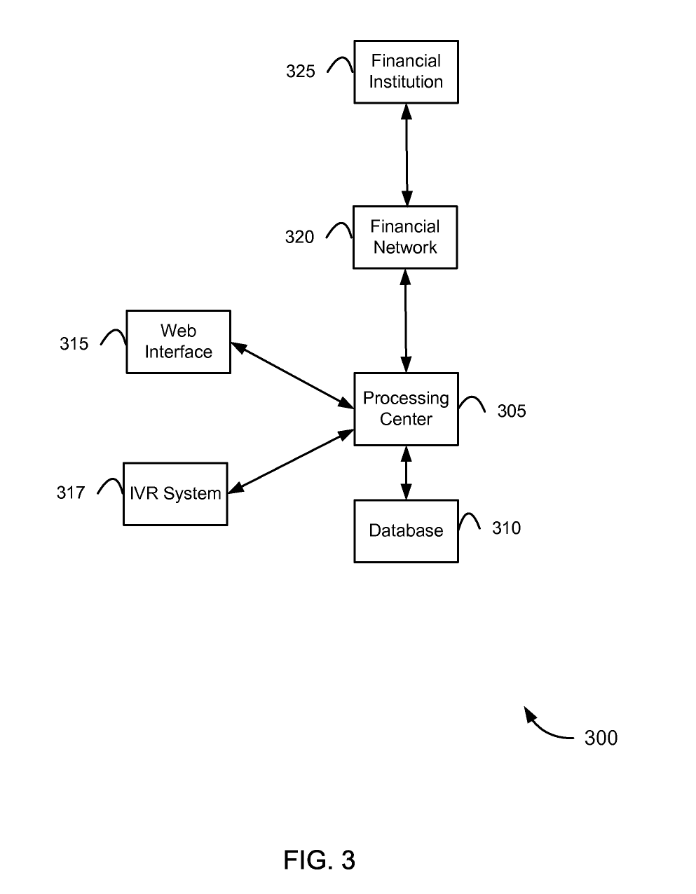

Now describing FIG. 3, which illustrates a system 300 for implementing enrollment authentication using a partial PAN, according to embodiments of the present invention, system 300 includes a processing center 305 coupled with a database 310. In one embodiment, processing center 305 may be configured to implement methods 100 and 200 from FIGS. 1 and 2. Furthermore, database 310 may be configured to store historical transaction data for customers serviced by processing center 305. Alternatively, such historical data may be stored by financial institution 325.

In one embodiment, processing center 305 may receive information including a partial PAN and issuing financial institution from a customer at a web interface 315. Through web interface 315, processing center 305 may present a series of transaction-related challenge questions to the customer. Based on the partial PAN and the answers to the challenge questions, processing center 305 identifies the unique complete PAN of the customer.

In one embodiment, processing center 305 may present the customer with mutual trust information. For example, processing center 305 may present for display, on web interface 315, a number of transactions performed by the customer, in order to assure the customer that processing center 305 is a legitimate authenticating authority.

Furthermore, web interface 315 may present the customer with a prompt to enter a telephone number and select/enter a phrase. For example, web interface 315 may present a number of phrases which could be selected (e.g., using a checkbox, a radio button, etc.), or a blank text box which allows the customer to enter a personal phrase.

Then, IVR system 317 is configured to receive the selected/entered phrase and telephone number, dial the telephone number, and play back the phrase. If the customer is convinced that the phrase is the phrase that he/she previously selected/presented, then IVR system 317 is able to establish a level of trust with the customer. Accordingly, IVR system 317 may prompt the customer to enter on the telephone keypad the customer's PIN associated with the determined PAN.

Using the PAN and PIN combination, processing center 305 may either execute a transaction request or forward a transaction request through financial network 320 to financial institution 325 to execute. Either way, if the request is authenticated, then processing center 305 may display such information to the customer via web interface 315, and the enrollment process may continue.

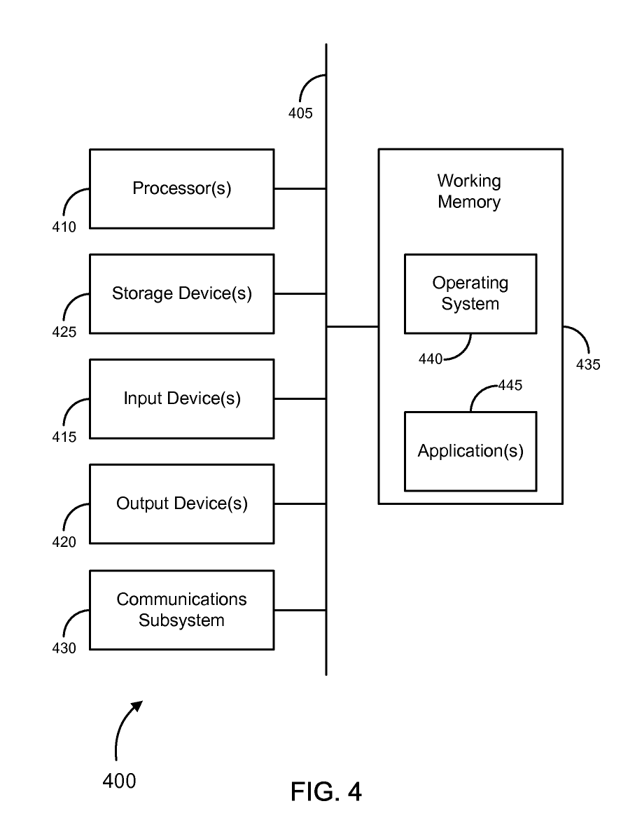

FIG. 4 provides a schematic illustration of one embodiment of a computer system 400 that can perform the methods of the invention, as described herein, and/or can function as, for example, processing center 305. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements can include one or more processors 410, including without limitation one or more general-purpose processors and/or one or more special-purpose processors (such as digital signal processing chips, graphics acceleration chips, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage and/or can include, without limitation, a disk drive, a drive array, an optical storage device, solid-state storage device such as a random access memory (“RAM”) and/or a read-only memory (“ROM”), which can be programmable, flash-updateable and/or the like. The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440 and/or other code, such as one or more application programs 445, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or code might be stored on a computer-readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 400) to perform methods of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another machine-readable medium, such as one or more of the storage device(s) 425. Merely by way of example, execution of the sequences of instructions contained in the working memory 435 might cause the processor(s) 410 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 400, various machine-readable media might be involved in providing instructions/code to processor(s) 410 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 425. Volatile media includes, without limitation dynamic memory, such as the working memory 435. Transmission media includes coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc., carried by the signals) to the working memory 435, from which the processor(s) 405 retrieves and executes the instructions. The instructions received by the working memory 435 may optionally be stored on a storage device 425 either before or after execution by the processor(s) 410.

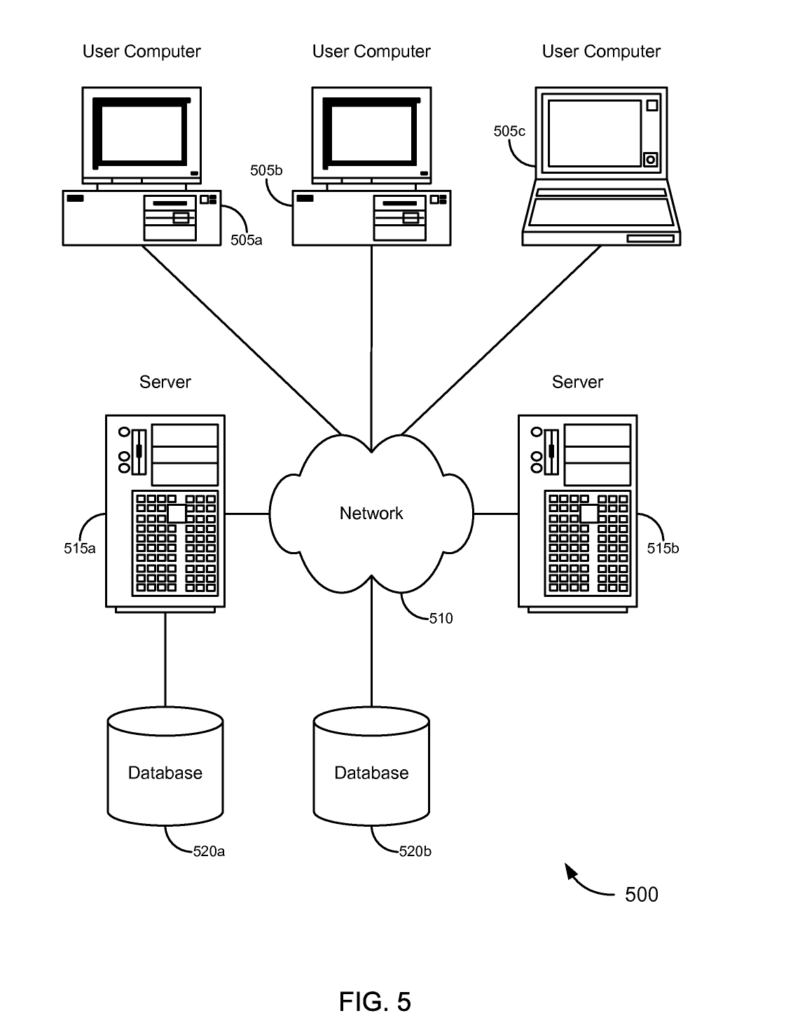

A set of embodiments comprises systems for implementing enrollment authentication using a partial PAN. Merely by way of example, FIG. 5 illustrates a schematic diagram of a system 500 that can be used in accordance with one set of embodiments. The system 500 can include one or more user computers 505. The user computers 505 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 505 can also have any of a variety of applications, including one or more applications configured to perform methods of the invention, as well as one or more office applications, database client and/or server applications, and web browser applications. Alternatively, the user computers 505 can be any other electronic device, such as a thin-client computer, Internet-enabled mobile telephone, and/or personal digital assistant (PDA), capable of communicating via a network (e.g., the network 510 described below) and/or displaying and navigating web pages or other types of electronic documents. Although the exemplary system 500 is shown with three user computers 505, any number of user computers can be supported.

Certain embodiments of the invention operate in a networked environment, which can include a network 510. The network 510 can be any type of network familiar to those skilled in the art that can support data communications using any of a variety of commercially-available protocols, including without limitation TCP/IP, SNA, IPX, AppleTalk, and the like. Merely by way of example, the network 510 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 515. Each of the server computers 515 may be configured with an operating system, including without limitation any of those discussed above, as well as any commercially (or freely) available server operating systems. Each of the servers 515 may also be running one or more applications, which can be configured to provide services to one or more clients 505 and/or other servers 515.

Merely by way of example, one of the servers 515 may be a web server, which can be used, merely by way of example, to process requests for web pages or other electronic documents from user computers 505. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 505 to perform methods of the invention.

The server computers 515, in some embodiments, might include one or more application servers, which can include one or more applications accessible by a client running on one or more of the client computers 505 and/or other servers 515. Merely by way of example, the server(s) 515 can be one or more general purpose computers capable of executing programs or scripts in response to the user computers 505 and/or other servers 515, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer 505 and/or another server 515. In some embodiments, an application server can create web pages dynamically for displaying the information in accordance with embodiments of the invention, such as a web interface for internet site 317 (FIG. 3) used to complete cardless financial transactions. Data provided by an application server may be formatted as web pages (comprising HTML, Javascript, etc., for example) and/or may be forwarded to a user computer 505 via a web server (as described above, for example). Similarly, a web server might receive web page requests and/or input data from a user computer 505 and/or forward the web page requests and/or input data to an application server. In some cases a web server may be integrated with an application server.

In accordance with further embodiments, one or more servers 515 can function as a file server and/or can include one or more of the files (e.g., application code, data files, etc.) necessary to implement methods of the invention incorporated by an application running on a user computer 505 and/or another server 515. Alternatively, as those skilled in the art will appreciate, a file server can include all necessary files, allowing such an application to be invoked remotely by a user computer 505 and/or server 515. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 520. The location of the database(s) 520 is discretionary: merely by way of example, a database 520a might reside on a storage medium local to (and/or resident in) a server 515a (and/or a user computer 505). Alternatively, a database 520b can be remote from any or all of the computers 505, 515, so long as it can be in communication (e.g., via the network 510) with one or more of these. In a particular set of embodiments, a database 520 can reside in a storage-area network (“SAN”) familiar to those skilled in the art. (Likewise, any necessary files for performing the functions attributed to the computers 505, 515 can be stored locally on the respective computer and/or remotely, as appropriate.) In one set of embodiments, the database 520 can be a relational database, such as an Oracle™ database, that is adapted to store, update, and retrieve data in response to SQL-formatted commands. The database might be controlled and/or maintained by a database server, as described above, for example.

While the invention has been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods of the invention are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with different embodiments of the invention.

Moreover, while the procedures comprised in the methods and processes described herein are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary features, the various components and/or features described herein with respect to a particular embodiment can be substituted, added and/or subtracted from among other described embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A method of implementing enrollment authentication, the method comprising:
receiving, by a processing system from a customer, a partial primary account number (PAN) and an identifier of an issuing financial institution of the partial PAN;
based on transaction history related to the partial PAN, presenting a plurality of challenge questions to the customer;
receiving, by the processing system from the customer, answers to the plurality of challenge questions;
based on the partial PAN, the identifier of the issuing financial institution, and the answers to the plurality of challenge questions, resolving, by the processing center, a complete PAN;
prompting the customer to select a mutual trust phrase;
receiving, by the processing system, the selected mutual trust phrase;
placing a call from an interactive voice response (IVR) system to the customer;
playing back to the customer the selected mutual challenge phrase;
receiving, from a telephone, the customer's personal identification number (PIN) associated with the complete PAN; and
using, by the processing system, the complete PAN and PIN combination to authenticate the customer.

2. A method of implementing enrollment authentication as in claim 1, wherein the receiving, from the telephone, the customer's personal identification number (PIN) associated with the complete PAN comprises receiving the PIN by one or more of the following methods: entered on a touch-tone keypad of the telephone, and spoken into the telephone's receiver and translated to text.

3. A method of implementing enrollment authentication as in claim 2, further comprising executing a transaction approval request using the complete PAN and PIN combination.

4. A method of implementing enrollment authentication as in claim 3, wherein the transaction approval request does not include an associated financial transaction.

5. A method of implementing enrollment authentication as in claim 3, further comprising:
processing the request; and
receiving an approval for the request.

6. A method of implementing enrollment authentication as in claim 5, further comprising, in response to receiving the approval, presenting the approval to the customer, and further authenticating the customer.

7. A method of implementing enrollment authentication as in claim 1, further comprising in response to authentication of the customer, processing an enrollment request for the customer.

8. A method of implementing enrollment authentication as in claim 1, further comprising, presenting information to the customer from the transaction history in order to establish mutual trust.

9. A method of implementing enrollment authentication as in claim 8, wherein the information comprises one or more of the following: audio, video, photo, transaction information, transaction amount, vendor name, and date of transaction.

10. A method of implementing enrollment authentication as in claim 1, wherein the partial PAN comprises the first four digits from the complete PAN and/or the last six digits in the complete PAN.

11. A method of implementing enrollment authentication as in claim 1, wherein the customer interfaces with the processing system via a web interface.

12. A method of implementing enrollment authentication as in claim 1, further comprising:
receiving the PIN as spoken during the telephone call; and
converting the spoken PIN into text using the IVR's Speech to Text functionality.

13. A machine-readable medium for implementing enrollment authentication, having sets of instructions which, when executed by a machine, cause the machine to:
receive from a customer a partial primary account number (PAN) and an identifier of an issuing financial institution of the partial PAN;
based on transaction history related to the partial PAN, present a plurality of challenge questions to the customer;
receive answers to the plurality of challenge questions;
based on the partial PAN, the identifier of the issuing financial institution, and the answers to the plurality of challenge questions, resolve a complete PAN;
prompt the customer to select a mutual trust phrase;
receive the selected mutual trust phrase;
place a call from an interactive voice response (IVR) system to the customer;
play-back to the customer the selected mutual challenge phrase;
receive, from a telephone, the customer's personal identification number (PIN) associated with the complete PAN; and
use the complete PAN and PIN combination to authenticate the customer.

14. machine-readable medium for implementing enrollment authentication as in claim 13, wherein the receiving, from the telephone, the customer's personal identification number (PIN) associated with the complete PAN comprises receiving the PIN by one or more of the following methods: entered on a touch-tone keypad of the telephone, and spoken into the telephone's receiver and translated to text.

15. A machine-readable medium for implementing enrollment authentication as in claim 13, wherein the sets of instructions which, when further executed by the machine, cause the machine to execute a transaction approval request using the complete PAN and PIN combination.

16. A machine-readable medium for implementing enrollment authentication as in claim 15, wherein the sets of instructions which, when further executed by the machine, cause the machine to process the request and receive an approval for the request.

17. A machine-readable medium for implementing enrollment authentication as in claim 13, wherein the sets of instructions which, when further executed by the machine, cause the machine to present information to the customer from the transaction history in order to establish mutual trust.

18. A machine-readable medium for implementing enrollment authentication as in claim 17, wherein the information comprises one or more of the following: audio, video, photo, transaction information, transaction amount, vendor name, and date of transaction.
